(19) United States
(12) Patent Application Publication
(10) Pub. No.: US 2009/0058823 A1
(43) Pub. Date: Mar. 5, 2009

(54) Virtual Keyboards in Multi-Language Environment

(75) Inventor: Ken Kocienda, Sunnyvale, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/028,960

(22) Filed: Feb. 11, 2008

Related U.S. Application Data
(60) Provisional application No. 60/969,918, filed on Sep. 4, 2007.

(51) Int. Cl. G06F 3/041; G06F 17/24; G06F 3/048

(52) U.S. Cl. 345/173; 715/257; 715/264; 715/773

(57) ABSTRACT

The disclosed implementations include displays of accented or related characters for characters selected by a user through a virtual keyboard operating in a multi-language environment. In one aspect, when a user clicks and holds down a key, a popup displays accented characters for the character associated with the key. In another aspect, the order of accented characters can be based a frequency of occurrence of the accented character in the current language being typed by the user. In another aspect, when a character is at edge of a display, the popup is visually displayed in a different location and the ordering of the accents in the display are set with the more frequently occurring accents being more quickly accessible. In another aspect, auto correction is used to correct accented equivalents for compounds. In another aspect, a different visual keyboard layout is provided for different languages.

### RELATED APPLICATION

This application claims the benefit of priority from U.S. Provisional Patent Application No. 60/969,918, filed Sep. 4, 2007, for “Virtual Keyboards In Multi-Language Environment,” which provisional patent application is incorporated by reference herein in its entirety.

### TECHNICAL FIELD

The subject matter of this application is generally related to information input devices.

### BACKGROUND

Typically, a computer device is configured to receive input of text and characters from a computer keyboard. Modern computer keyboards are composed of rectangular or near-rectangular keys, and characters, such as the letters A-Z in the English alphabet, are usually engraved or printed on the keys. In most cases, each press of a key corresponds to typing of a single character.

Traditional computer keyboards may sometimes be too large for portable devices, such as cellular phones, MPEG-1 Audio Layer 3 (MP3) players, or personal digital assistants (PDAs). Some portable devices include a smaller version of the traditional computer keyboard or use a virtual keyboard to receive user input. A virtual keyboard can be of the form of a software application or a feature of a software application to simulate a computer keyboard. For example, in a stylus-operated PDA or a touch-sensitive display on a communication device, a virtual keyboard can be used by a user to input text by selecting or tabbing keys of the virtual keyboard

These smaller keyboards and virtual keyboards may have keys that correspond to more than one character. For example, some of the keys can, by default, correspond to a common character in the English language, for example, the letter “a,” and may also correspond to other additional characters, such as another letter or the letter with an accent option, e.g., the character “ä,” or other characters with accent options. Because of the physical limitations (e.g., size) of the virtual keyboard, a user may find it difficult to type characters not readily available on the virtual keyboard.

### SUMMARY

The disclosed implementations include displays of accented or related characters for characters selected by a user through a virtual keyboard operating in a multi-language environment. In one aspect, when a user clicks and holds down a key, a popup displays alternative (e.g., accented) characters associated with the key. In another aspect, the order of accented characters can be based a frequency of occurrence of the accented character in the current language being typed by the user. In another aspect, when a character is at edge of a display, the popup is visually displayed in a different location and the ordering of the accents in the display are set with the more frequently occurring accents being more quickly accessible. In another aspect, auto correction is used to correct accented equivalents (e.g., useful for French) and for compounds (e.g., useful for German). In another aspect, a different visual keyboard layout is provided for different languages.

Other implementations are disclosed, including implementations directed to systems, methods, apparatuses, computer-readable mediums and user interfaces.

### DESCRIPTION OF DRAWINGS

FIG. 1 shows an example portable device with a virtual keyboard.

FIGS. 2, 3A and 3B show examples of virtual keyboards displaying accent options.

FIGS. 4-6 show examples of providing a correction suggestion for a text input in a portable device.

FIGS. 7A-7E show examples of virtual keyboard layouts.

FIG. 8 is a flow diagram illustrating an example method for providing one or more characters for typing on a virtual keyboard.

FIG. 9 is a flow diagram illustrating an example method for correcting a text input.

FIG. 10 is a flow diagram illustrating an example method for determining a liaison in a French input.

FIG. 11 is a flow diagram illustrating an example method for correcting a compound in a German input.

FIG. 12 is a block diagram of an example system architecture for performing the operations described in reference to FIGS. 1-11.

### DETAILED DESCRIPTION

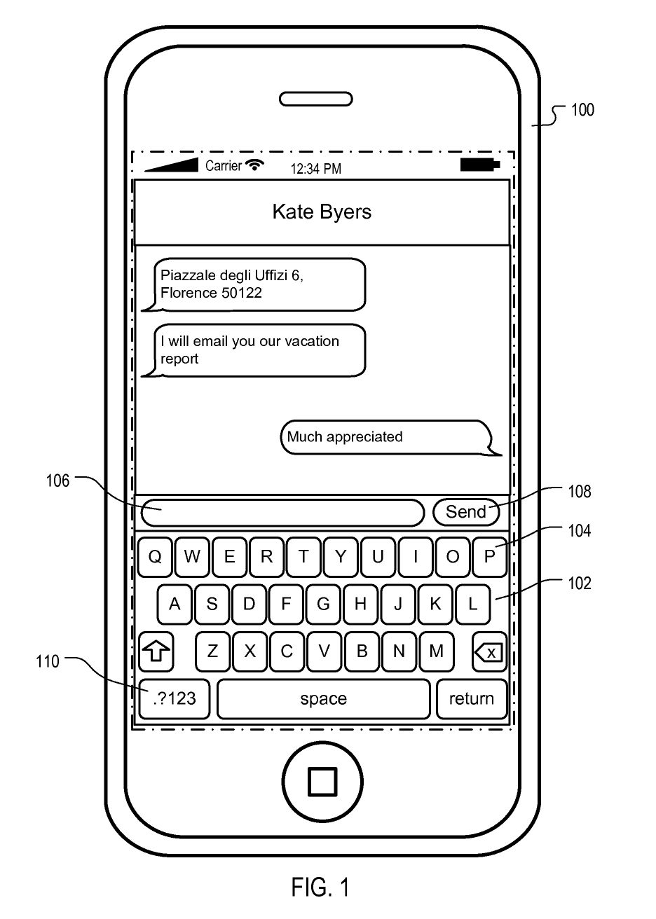

FIG. 1 shows an example portable device 100 with a virtual keyboard 102. For example, the portable device 100 can be a cellular phone, a personal digital assistant (PDA), or a portable media device (e.g., a portable MPEG-1 Audio Layer 3 (MP3) player, a portable DVD player, etc.). Some examples of the portable device 100 may be an iPhone™ or an iPod™ of Apple Inc. in Cupertino, Calif. In one implementation, the portable device 100 includes a touch screen display that displays the virtual keyboard 102.

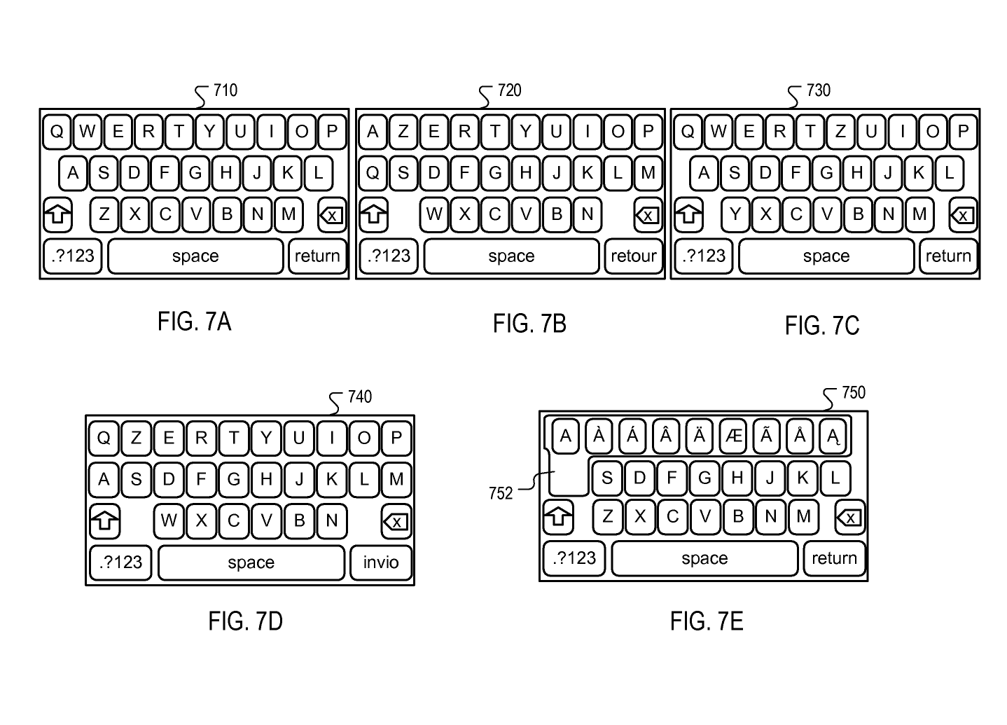

The virtual keyboard 102 includes buttons or keys 104. For example, each of the keys 104 corresponds to a character. In one example, the user can select a character by touching a display area of a key corresponding to the character. In the depicted example, the virtual keyboard 102 displays the keys 104 in an English keyboard layout. In some implementations, the virtual keyboard 102 is capable of displaying the keys 104 using other keyboard layouts. For example, the virtual keyboard 102 is configured to “swap” (e.g., exchange) a currently displayed keyboard layout with another keyboard layout upon receiving a user request. Some examples of virtual keyboard layouts are described with reference to FIGS. 7A-7E.

Various software applications can be executed by the portable device 100. In the depicted example, the portable device 100 is executing an instant messaging (IM) application. For example, a user can use the IM application to communicate with one or more users through a network, such as the Internet. Other software applications can also be used with the virtual keyboard 102. For example, the virtual keyboard 102 can be used with an email application, a text editing application, or other applications that allow users to input text.

The user uses the virtual keyboard 102 to input text for the IM application. As shown, the IM application includes an input box 106 for displaying text input by the user. For example, the user can input text to compose a message by selecting characters from the virtual keyboard 102. After inputting the message, the user can select a send button 108 to transmit the message to the remote user.

The virtual keyboard 102 includes an action button 110 to provide keyboard functions. For example, the user can use the action button 110 to input characters not represented by the keys 104, such as punctuation characters (e.g., period (“.”) or comma (“,”)) and “numeric characters (e.g., “1”, “2’, and “3”).

In some implementations, the action button 110 can be used to configure the virtual keyboard 102. In one example, the action button 110 can be used to configure a keyboard layout of the virtual keyboard 102. For example, a user can use the action button 110 to change the virtual keyboard 102 from displaying an English keyboard layout to a French keyboard layout. In one example, the action button 110 can be used to configure an input language of the virtual keyboard 102. For example, the user can use the action button 110 to select a language (e.g., English, French, German, etc.) of the virtual keyboard 102.

Based on the user-selected input language, the portable device 100 can perform various functions to assist users' typing. In some implementations, the portable device 100 can provide input correction to the input text. For example, the virtual keyboard 102 can automatically determine one or more correction options of a user input based on a user's typing location and the user-selected language. For example, suppose a user inputs “dat” and the user-selected language is English. Based on the user-selected language, the portable device 100 can verify whether the user input is correct. In one example, since “dat” is not a word in English, the portable device can verify that the user input is incorrect. In some examples, the portable device 100 can then provide a corrected user input by detecting a typing location of the user. For example, suppose the user selects the letter “d” near the right edge of the key “D.” Based on the typing location, the portable device 100 may select to provide a correction of “fat.” In some examples, the portable device 100 selects to provide “fat” rather than “eat” because the letter “F” is nearer to the location of the user's typing.

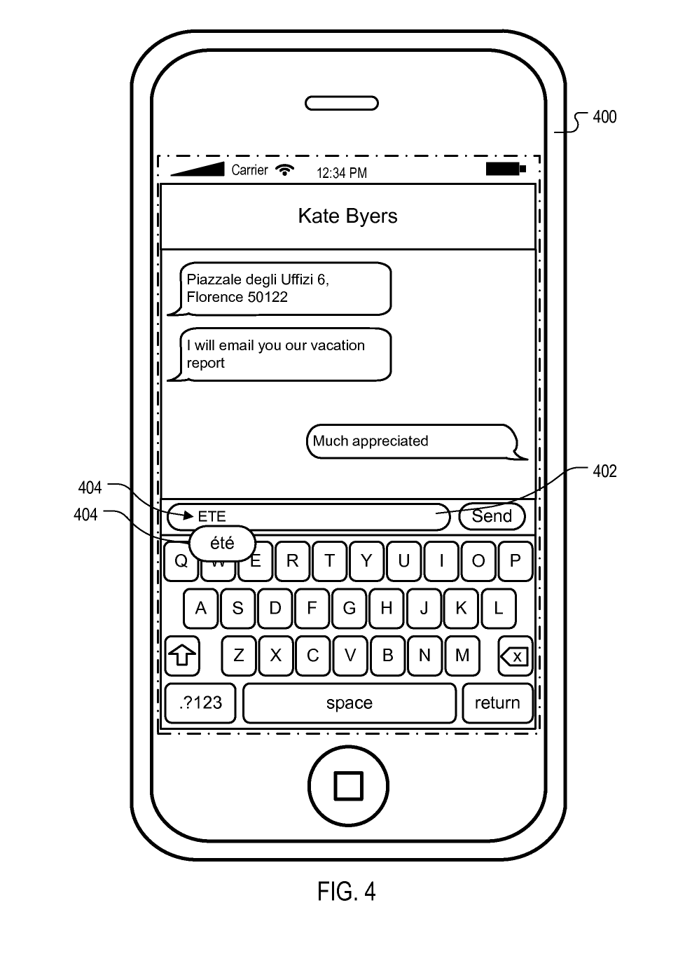

In other user-selected languages, the portable device 100 can include other language specific variances to correct user inputs. In one example, the portable device 100 can use accent options available in the user-selected language to correct the user input. In one example, the portable device 100 can use a special form of the language to determine a correction of user input. For example, if the user-selected language is French, the portable device 100 can determine whether a liaison variation of the user input can be a correction. For example, if the user-selected language is German, the portable device 100 can determine whether the input word is a compound word and correct the user input by parsing the compound words into constituent words. Various examples of using user-selected language to correct user input are described with reference to FIGS. 4-6.

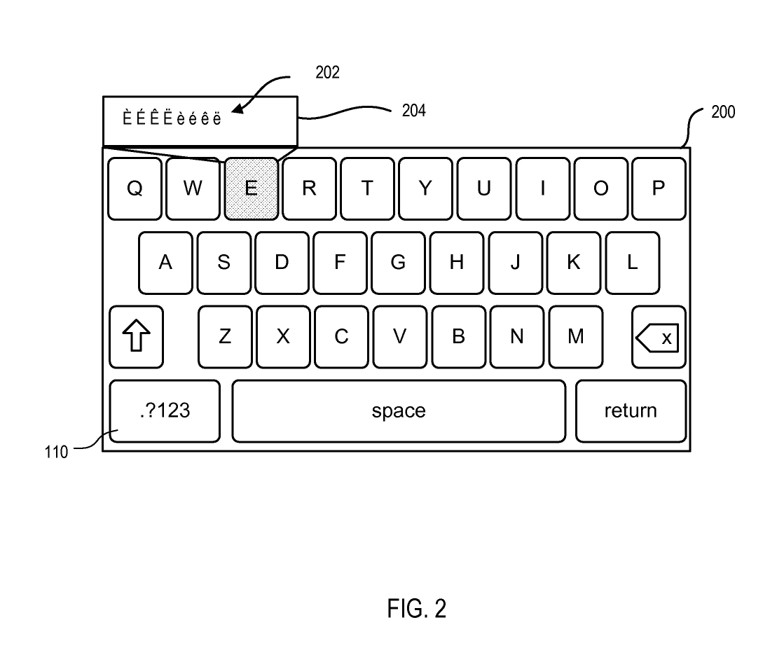

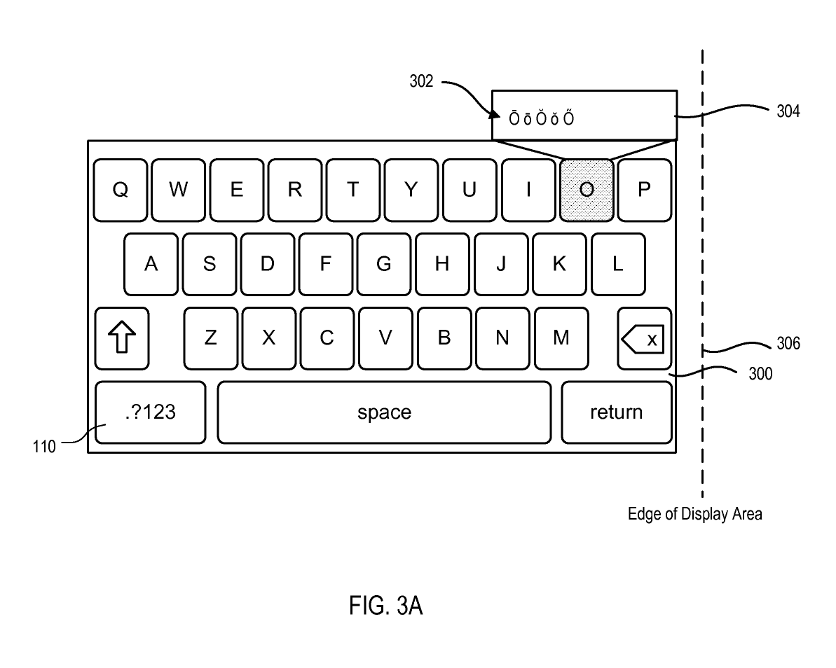

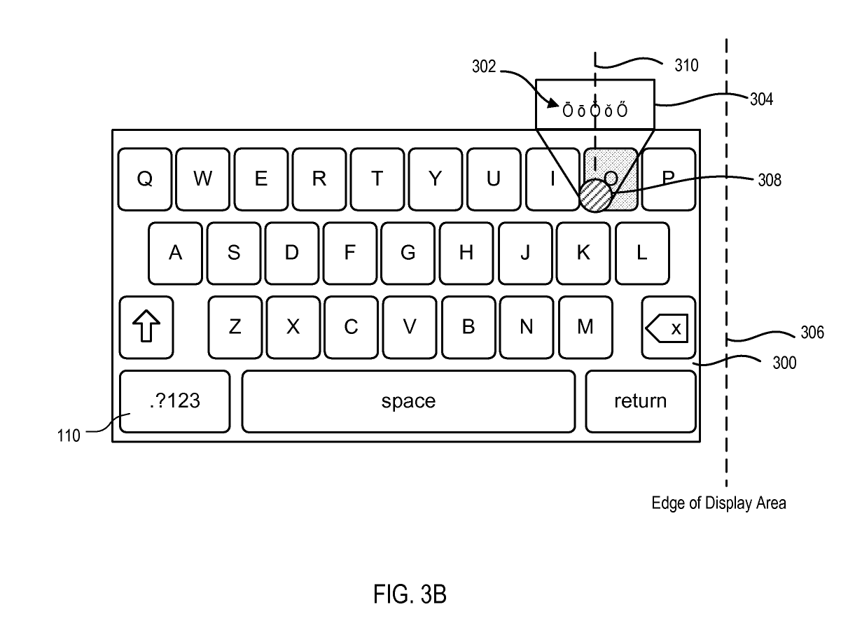

In some implementations, the virtual keyboard 102 can be configured to display accent options of a selected character. Various languages (e.g. French, German, Italian, etc.) include characters with a diacritical mark to indicate an accent of the character in a word. When a user selects to input these languages (e.g., by setting the language using the action button 110), the virtual keyboard 102 may display the accent options upon detecting a user request. FIGS. 2-3 show examples of virtual keyboards 200, 300 displaying accent options. For example, the virtual keyboards 200, 300 can be implemented in the portable device 100 in FIG. 1.

As shown in FIG. 2, the virtual keyboard 200 is displaying accent options 202 for a character “E” in a popup window 204. For example, a user can select one of the accent options 202 (e.g., by touching one of the displayed accent options 202) to be input to the input box 106.

In some implementations, the popup window 204 is activated by detecting one or more touches or gestures of the user using one or more fingers or a stylus. In one implementation, the popup window 204 can be activated if, for example, the portable device 100 detects that the user holds down the letter “E” longer than a predetermined time (e.g., 2 seconds). Other user input, touches or gestures can also be used to activate the popup window 204. In one implementation, the popup window 204 can be activated if the user holds the key of the character “E” and the action button 110 at the same time. In some implementations, the virtual keyboard 200 can be configured so that the popup window 204 is activated if the user selects a character with accent options available in the user-selected language.

In some implementations, different sets of the accent options 202 may be selected to be displayed based on the user-selected language. In one example, German letters only use an umlaut as an accent option and the umlaut accent is only available to “a,” “o,” and “u” letters in German. For example, if the user selects to input German, then the display window 204 may activate the popup window 204 that includes an umlaut accent option if the user selects an “a,” “o,” or “u” letter.

In some implementations, the accent options 202 are displayed in an order to display more frequently used accent options in a more accessible display area in the popup window 204. In one example, the virtual keyboard 200 can dynamically determine an order to display the accent options 202 based on a dictionary of a user-selected language. For example, the popup window 204 may display accent options 202 in a descending (or ascending) order based on frequency of occurrence.

In one implementation, the order of the accent options 202 may be based on a statistical estimation based on the dictionary. For example, the portable device 100 can count the occurrence of each of the accent options 202 based on a sample of data (e.g., a large sample of documents). Based on the counts, the portable device 100 can determine occurrence frequencies for the accent options 202. For example, an accent option with 10 counts may be determined to have a higher frequency than an accent option with 5 counts. In some implementations, the counts of each of the accent option can be stored in the portable device 100 during manufacturing of the device 100. In some implementations, the counts can be updated to the device 100 from an external server.

In one implementation, the order of the accent options 202 may be determined based on previous user inputs. For example, the portable device 100 can determine a probability distribution of a next user input based on the previous user inputs.

In another implementation, the portable device 100 can generate a probability distribution using a dictionary of the user-selected language. For example, the portable device 100 may include a probability model for the user-selected language based on the dictionary. For example, the probability model may be a unigram model of the characters in the user-selected language. Based on the language model and the previous user inputs, selection probabilities of the accent options 202 may be determined. Using the selection probabilities, the virtual keyboard 200 application may determine occurrence frequencies for the accent options 202. For example, an accent option with a higher selection probability may be determined to have a higher frequency than an accent option with a lower selection probability.

Various arrangement schemes can be use to order the accent options based on the occurrence frequencies. In some examples, the accent option with the highest occurrence frequency may be displayed in the left most position of the popup window 204. Other arrangements can also be used. In some examples, the virtual keyboard 200 can determine the location of the highest probability accent option by determining a location with least amount of movement of the user's typing hand to select the highest occurrence frequency accent option. Thus, the accent options can be displayed so that the most frequency occurring accent option is displayed closest to the users input (e.g., touch actuation).

In some implementations, the user can use the action button 110 to arrange a display order of the accent options 202. For example, the user can rearrange an order of the accent options 202 after activating the popup window 204 by holding the action button 110 and moving (e.g., by a click and move motion) an accent option to a user desired position.

As shown in FIG. 3A, the virtual keyboard 300 displays accent options 302 for a letter “O” in a popup window 304. For example, the user can activate the popup window 304 by holding the letter “O” for more than a predetermined time to display the accent options 302.

In some implementations, a position of the popup window 304 and an order of the accent options 302 are determined based on a position of a key corresponding to the selected character. For example, if the key is near an edge 306 of the display area, then the popup window 304 may be displayed in a different location to avoid the edge 306. For example, the letter “O” is located near the edge 306, and the popup window 304 is displayed at a location different from the display location of the popup window 204 as shown in FIG. 2.

In some implementations, the portable device 100 can be configured to dynamically determine a display location for the accent options 302. In one example, the portable device 100 can determine the display location based on a position of the selected key. For example, the portable device can display the accent options 302 at a location proximate to, e.g., above the selected letter “O” (e.g., centering the accent options 302 above a center of the selected letter “O”) in FIG. 3A. Likewise, accent options for the letter “U” could be centered above the letter “U,” etc.

In another implementation, as shown in FIG. 3B, the portable device can determine the display location based on a position of a touch actuation location. FIG. 3 shows a touch location 308 and a projection line 310 of the touch location 308. For example, the user can activate the popup window 304 by holding a finger at the touch location 308. In one example, the portable device 100 determines a proximate location above the touch location 308 along the projection line 310. For example, the portable device 100 can centrally display the accent options 302 and the popup window relative to the touch actuation, e.g., at the projection line 310.

In one implementation, an order of the accent options 302 may also be displayed in different directions based on the location of the key. For example, the accent options 202 of FIG. 2 can be displayed in a descending order from right to left to place the most frequency occurring accent near the middle of the display. Conversely, in the example shown in FIGS. 3A and 3B, the accent options 302 are displayed in an ascending order from right to left to place the most frequency occurring accent near the middle of the display.

In some implementations, the user can use the action button 110 to configure a position of the popup window 304. For example, the user can fix a position of the popup window 304 by holding the action button 110 and move the popup window 304 to a user-desired position. In some implementations, the user can also use the action button to disable dynamic ordering of the accent options 302 so that the accent options are always displayed in a fixed (e.g., a user-selected) order.

FIGS. 4-6 show examples of providing input corrections for a user input in a portable device (e.g., the portable device 100 in FIG. 1). For example, the input correction can be determined based on a user-selected language. As shown in FIG. 4, a portable device 400 includes an input box 402 for displaying user text input in an IM application. In the depicted example, the input box 402 includes a word 404, “ete.”

The portable device 400 can correct the word 404 based on accent variants of the word 404. As an illustrative example, suppose the user-selected language is French. After determining the word 404 is not a correct word in French, the portable device 400 generates correction options for the word 404 based on accent variations of the characters included in the word 404 in French. As shown, the portable device 400 provides a correction option, “été” (meaning Summer time in French), in a popup window 406. For example, the user can select the correction option in the popup window 406 to replace the word 404.

In some implementations, the correction option can be determined based on the user-selected language and statistics (e.g., a user dictionary or a history of user typing data for the user-selected language). For example, the popup window 406 may include the most probable correction option according to the determination. In other examples, more than one correction option may be displayed, and the correction options may be displayed in descending order or probability. An example method of determining correction options for virtual keyboards is described in U.S. patent application Ser. No. 11/228,737, for “Activating Virtual Keys of a Touch-screen Virtual Keyboard,” which patent application is incorporated by reference herein in its entirety.

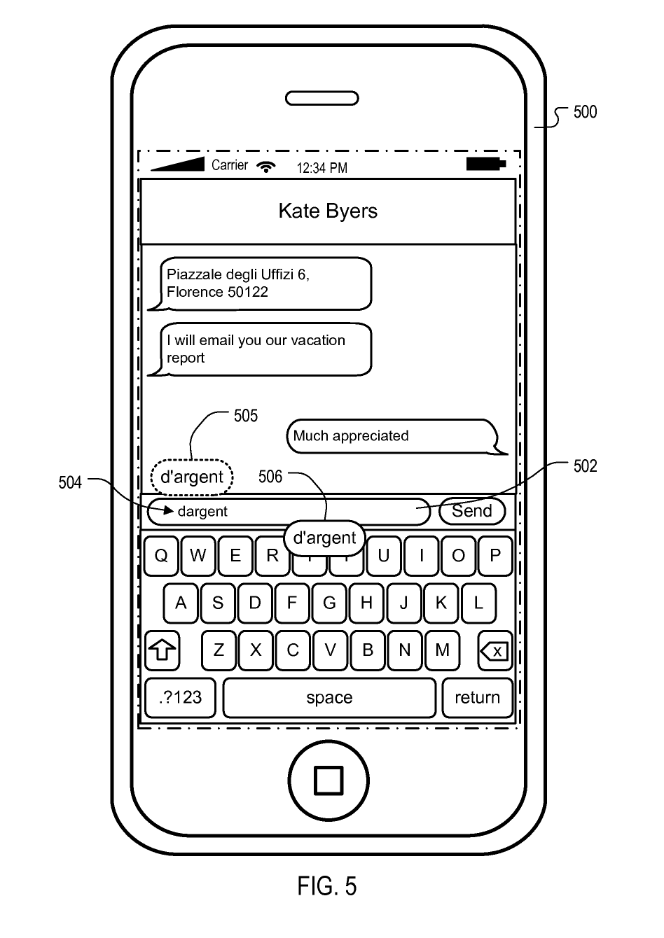

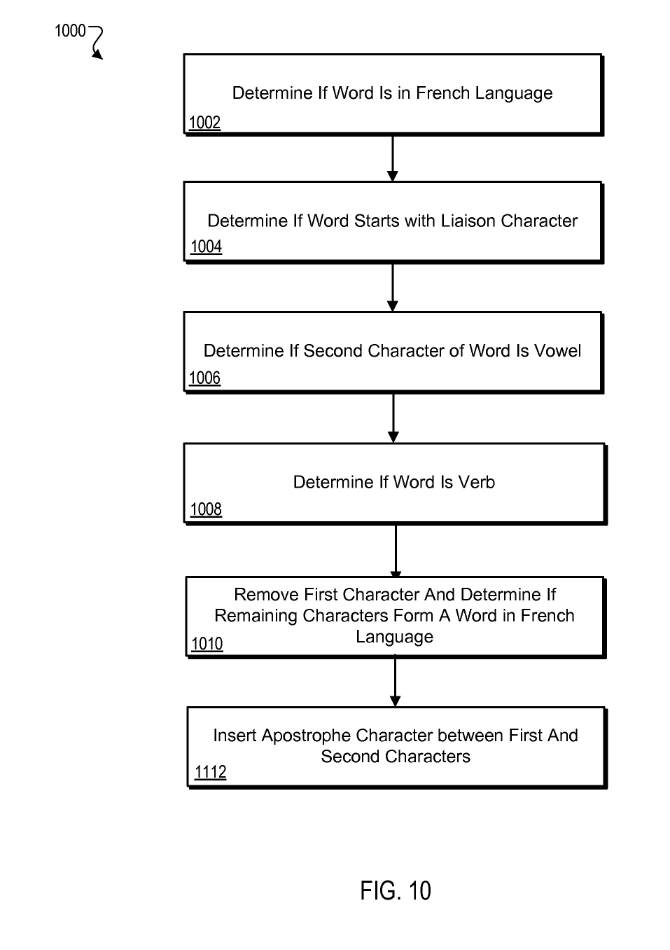

In some implementations, a portable device can correct a user input word by recognizing a liaison variant of the user input word if the user input is in French. As shown in FIG. 5, a portable device 500 includes an input box 502. The input box 502 includes an input word 504, “dargent.” In this example, the user-selected language is French. After determining that the word 504 is not a correct French word, the portable device 500 may determine a correction option for the word 504. In some implementations, the portable device 500 may determine whether a liaison variant of the word 504 is a correct French word. In this case, a liaison variant of the word 504 is “d'argent,” which is a proper French word. Thus, the portable device 500 may display the liaison variant “d'argent” in a popup window 506, and the user can select the word in the popup window 506 to replace the word 504. An example method for determining a liaison variant of a French input is described with reference to FIG. 10.

In one implementation, the popup window 506 can be displayed near the most recently letter actuated/input by the user, e.g., “t”, or centered above the location of the touch actuation on the touch-sensitive display so that the user may conveniently select the suggested replacement without significantly repositioning his or her finger or stylus. Other display positioning techniques can also be used. For example, the popup can be displayed proximate to the word, as indicated by the dashed popup 505.

In some implementations, the portable device 500 can add the liaison variants, for example, “d'argent,” to the French dictionary. For example, the portable device 500 may includes a dynamic dictionary for each of the languages. In one implementation, the portable device 500 may add a liaison variant of a user input if the portable device 500 determines that the liaison is a frequently used word. For example, the portable device 500 can determine that a word is frequently used if the word is input by the user more than a predetermined number of times (e.g., 5 times). Other schemes for determining whether a word is a frequently used word can also be used. For example, the portable device 500 can determine a frequently used word based on a frequency threshold. In one implementation, the portable device 500 compares the user's acceptances of a liaison variant as a correction, updates an acceptance rate and compares the acceptance rate to a frequency threshold (e.g., a 50% threshold). For example, if the acceptation rate is higher than 50%, then the portable device determines the word is a frequently used word and adds the word in the dictionary.

After adding the liaison variant to the dictionary, for example, the liaison variant can be available to the input correction method with other user inputs. For example, after adding the word “d'argent” to the dictionary, the portable device 500 can use the word “d'argent” as a correction option for a user input “cargent.”

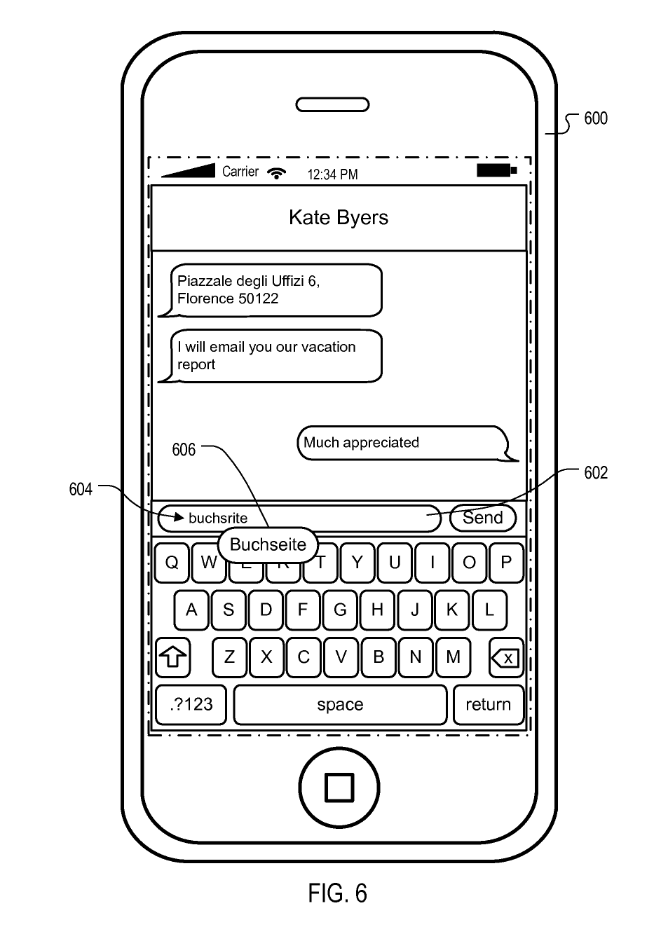

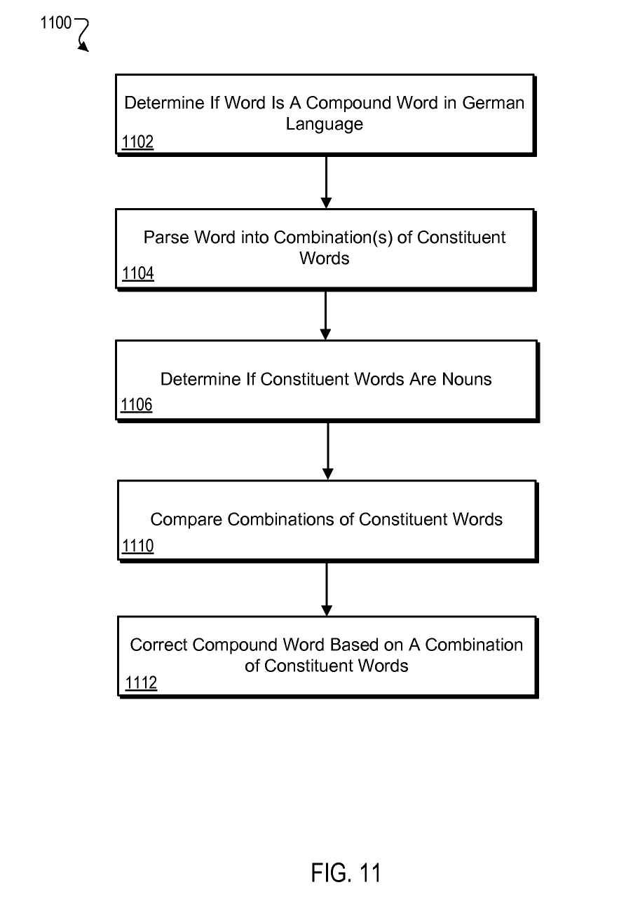

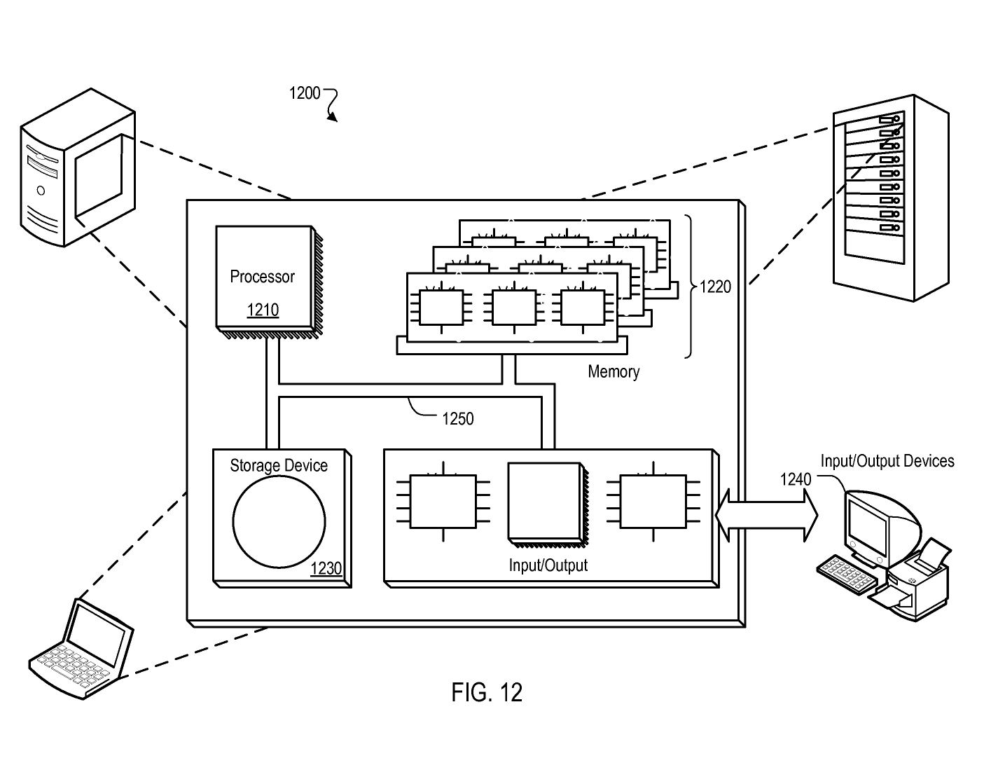

In some implementations, the user input can be corrected by determining that the user input is a compound word. In some languages, such as German, compound words may be represented as one word without any delimiter to separate each constituent word. In some examples, the portable device may provide a more accurate correction option if the constituent words of the compound word are identified. As an illustrative example, in FIG. 6, a portable device 600 includes an input box 602. In the depicted example, the input box 602 includes an input word 604, “buchsrite.” The portable device 600 may determine that the word 604 is not a correct German word because the word 604 is not found in a German dictionary accessible by the portable device 600. To facilitate a more robust error correction process, the portable device 600 can be configured to identify constituent words in a compound word. In the example shown in FIG. 6, the portable device 600 can identify two constituent words “Buch” and “Seite” based on the word 604. For example, the portable device 600 can parse the word 604 and identify a word “Buch.” After identifying the word “Buch” in the word 604, for example, the portable device 600 determines that the remaining word “Srite” is an input error but can be properly corrected to “Seite.” As a result, the portable device 600 displays a correction option “Buchseite” in a popup window 606. For example, the user can select the correction option in the popup window 606 to replace to word 604. An example method of correcting compound words is described with reference to FIG. 11.

Similar to adding the liaison variants in the dictionary as described with reference to FIG. 5, the portable device 600 can add the compound word “Buchseite” into the dictionary if the portable device 600 determines that the compound word is a frequently used word. For example, a compound word can be used as a correction option for additional user inputs if the compound word is added to the dictionary.

FIGS. 7A-7E show examples of virtual keyboard layouts 710, 720, 730, 740, 750 of the virtual keyboard 102 (FIG. 1). In some examples, the portable device 100 can display the virtual keyboard layouts 710, 720, 730, 740, 750 based on a user selection. For example, the user can select to display one of the virtual keyboard layouts 710, 720, 730, 740, 750 using the action button 110. As show, the keyboard layout 710 is an English keyboard layout, the keyboard layout 720 is a French keyboard layout, the keyboard layout 730 is a German keyboard layout, and the keyboard layout 740 is an Italian keyboard layout.

In certain implementations, the user can customize a keyboard layout for inputting multiple languages. For example, the keyboard layout 750 of FIG. 7E is an English keyboard layout. However, the user can configure the layout 750 to display accent options 752. In some examples, the user can use the English keyboard layout 750 to input text in English and other languages. In one example, the accent options 752 may be displayed if the user activates the portable device to display the accent options 752, such as, by selecting and holding the letter “A” for a predetermined duration. In some implementations, the user can also configure an order of the accent options 752 displayed. For example, the user can reorder the accent options 752 by selecting one of the accent options, moving the selected accent option to a new position, and releasing the selected accent option.

In various implementations, the portable device 100 can change to display different virtual keyboards layouts 710, 720, 730, 740 upon, for example, detecting a swipe gesture from the user. In one implementation, a portable device (e.g., the portable device 100) changes the displayed keyboard layouts 710, 720, 730, 740 upon detecting a swipe motion from the user. For example, the swipe motion may be detected if the user swipes his/her finger across the display from left to right (or from right to left) of the virtual keyboard 102.

In some implementations, other touches or gestures can be used to change the display of the virtual keyboard layouts 710, 720, 730, 740. For example, the keyboard layouts 710, 720, 730, 740 can be rotated upon detecting a user selection of, for example, the action button 110 and a space key of the virtual keyboard 102 at the same time.

In some implementations, the rotation of the virtual keyboard layouts 710, 720, 730, 740 can be animated. For example, the virtual keyboard layouts 710, 720, 730, 740 can be swapped smoothly by rolling a present layout out of the display and a next layout into the display. In another example, two of the virtual keyboard layouts 710, 720, 730, 740 can be swapped by animating the keys to move (e.g., using a jumping motion) from their old position in the current layout to their new positions in the next layout.

In some implementations, the user can configure a display order of the keyboard layouts 710, 720, 730, 740. For example, a current display order of the layouts 710, 720, 730, 740 may follow an order 710, 720, 730, 740. That is, if a current keyboard layout is the layout 710, a next layout to be displayed is the layout 720, and so on. When the portable device displays the keyboard layout 740, the display of the keyboard layout may “loop around” and the next keyboard layout to be displayed is the layout 710.

In some implementations, the portable device can reorder a display sequence of the keyboard layouts 710, 720, 730, 740 by detecting a user touch or gesture. For example, the user can configure the display sequence using a swipe-and-hold gesture. In one example, the user can first select the keyboard layout 720 and swipe across the display. Next, the user can hold, for example, at the edge of the display without releasing after the keyboard layout 730 appears. Upon detecting such user gesture, the portable device may, for example, display the keyboard layout 740. At this time, after the keyboard layout 740 appears, if the user releases the selected keyboard 720, the portable device 100 may configure the display sequence by placing the layout 720 between the layouts 730 and 740.

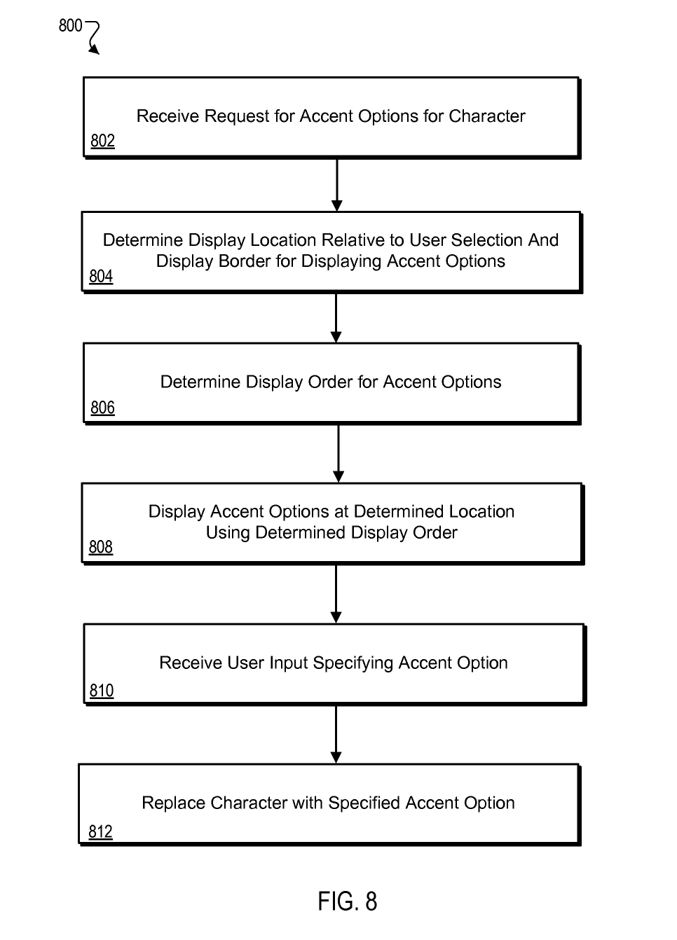

FIG. 8 is a flow diagram illustrating an example method 800 for providing one or more accent options for typing on a virtual keyboard. For example, a portable device (e.g., the portable device 100) can use the method 800 to display one or more accent options (e.g., the accent options 202) for user to type characters with a diacritical mark. The method can be used alternatively to display other character variations, or associated characters or symbols as required. The method 800 begins with receiving a request for accent options for a character (802). For example, the portable device 100 determines that a request is received if a character is selected and held for a predetermined length of time.

Next, the method 800 determines a display location relative to a key and a display border for displaying accent options (804). In some implementations, the portable device 100 determines a location for the popup window 204 or 304 to be displayed based on relative distance from the selected key and edges of the display. In one example, the portable device 100 can determine a display location to avoid an edge of the display if the selected character key is close to the edge. In some implementations, the portable device 100 can determine the location based on a touch actuation location. For example, the portable device can center the accent options 302 based on the touch location 308 for activating the popup window 304.

The method 800 determines a display order for the accent options (806). For example, the portable device 100 can determine a display order for the accent options based on occurrence frequencies of the accent options. In one implementation, the portable device 100 may display the more frequently occurred accent options in a more accessible area of the popup window 204 or 304.

The method 800 displays the accent options at the determined location using the determined display order (808). For example, the portable device 100 can display the accent options 202 after determining the location of the popup window 204 and the order of the accent options 202.

The method 800 receives a user input specifying one of the displayed accent options (810). For example, the portable device 100 may receive a user input from the popup window 204 after the user clicks on one of the accent options 202.

Next, the method 800 replaces the selected character with the specified accent option (812). For example, the portable device 100 may use the selected accent option as an input to the input box 106.

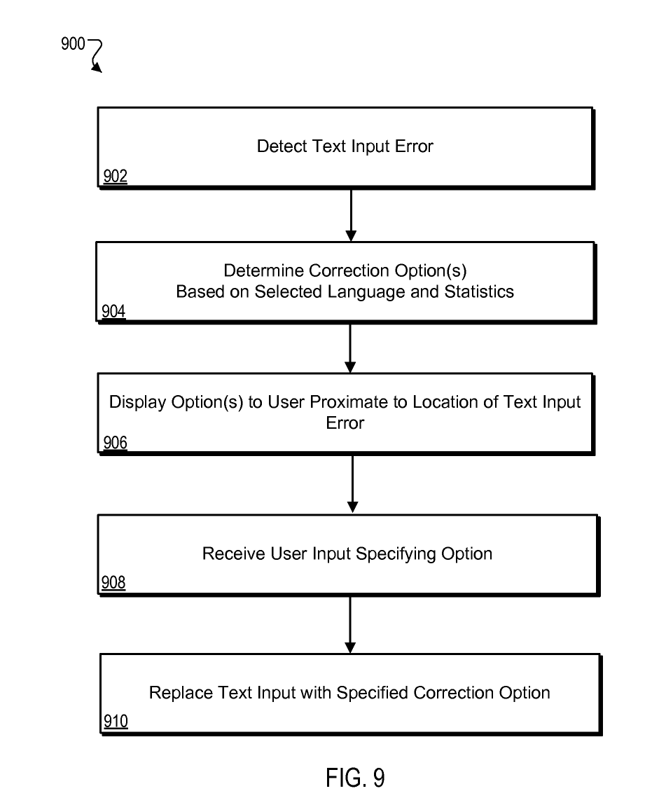

FIG. 9 is a flow diagram illustrating an example method 900 for correcting a text input. For example, the method 900 can be performed by a portable device (e.g., the portable device 400). The method 900 begins with detecting a text input error (902). For example, the portable device 100 can verify the text input in the input box 106 using one or more dictionaries. For example, the portable device 100 may determine that a text input is an error if the text input is not included in the dictionary of a user-selected language.

The method 900 determines one or more correction options based on a selected language and statistics (904). In some examples, the portable device 100 can determine one or more correction options based on, for example, words stored in the dictionary of the user-selected language. In one example, the portable device 100 can use language specific accent options of the input characters to select the correction options. For example, the portable device 400 provides a correction option of “été” for the text input “ete.” In some examples, the correction options are determined based on statistics. For example, the portable device 400 can determine the correction options using a unigram model developed based on a dictionary of the user-selected language. In some examples, the correction options are determined based on one or more special features of the user-selected language. For example, if the user-selected language is French, then the portable device 100 may consider liaison variants of the user input as correction options. In another example, if the user-selected language is German, then the portable device 100 may consider the user input as a compound word to determine correction options.

Next, the method 900 displays the correction options to the user proximate to a location of text input error (906). For example, the correction options may be displayed in a popup window that is displayed near the incorrect text input. For example, the portable device may also display the popup window to avoid an edge of the display, or may display the popup window near the last letter the user input, or may display the popup window centered relative to the location of the touch actuation on a touch sensitive display.

After displaying the correction options, the method 900 receives user input specifying one of the options (908). For example, in the example shown in FIG. 4, the user can touch and select the correction option “été” displayed in the popup window 406.

The method 900 replaces text input with the specified correction option (910). For example, the portable device 400 can replace the text input in the input box 402 with the correction option. In some examples, the user need not select any of the correction options displayed in the popup window. For example, the user can ignore the popup window and continue typing, or the user may close the popup window by selecting a close button of the popup window. If the user does not select any of the correction options, the portable device 400 may leave the text input unchanged. In some implementations, the user may add the text input into the dictionary so that the text input may be considered a valid input.

FIG. 10 is a flow diagram illustrating an example method 1000 for determining a liaison in a French input. For example, the method 1000 can be performed by a portable device (e.g., the portable device 500). The method 1000 begins with determining whether a word is in the French language (1002). For example, the portable device 500 can determine whether a word is in the French language by checking a user-selected language. If the user-selected language is French, then the portable device 500 determines that the word is in the French language.

Next, the method 1000 determines whether the word starts with a liaison character (1004). For example, the portable device 500 can determine whether the word 504 “dargent” starts with a liaison character, such as “D” or “L.”

If the word starts with a liaison character, then, in some cases, the method 1000 determines whether the second character of the word is a vowel (1006). For example, the portable device 500 determines whether the second character “a” in the word “dargent” is a vowel. In other cases, the method 1000 does not determine whether the second character of the word is a vowel but rather checks the third or fifth letter in the word, for example. In French, “qu” can be used as a liaison prefix (e.g., “qu'elle”), resulting in the method 1000 determining whether the third character of the word is a vowel or “y”, for example. Other languages (e.g., Italian) use longer prefixes like “nell” (e.g., in the Italian word “nell ' archipelago”), in which case the method 1000 determines if the fifth letter of the word is a vowel. Thus, the appropriate character in a liaison candidate word is checked by the method 1000 given an eligible set of liaison prefixes for the target language. Additional factors could include a determination of the part of speech of the candidate word, a consultation of words the user has previously typed, or a lookup of the candidate word in a corpus of text in the target language.

If the second character is a vowel, then, in some cases, the method 1000 determines if the word is a verb (1008). For example, if the user wanted to type “My name is Ken” in French, the user would type “Je m' appelle Ken.” In this case, if the user actually typed “mappelle” on the device 500, the method 1000 would recognize that “appelle” is a verb, and that “m” is a suitable liaison prefix character for verbs.

If the word is a verb, then the method 1000 removes the first character of the word and determines whether the remaining characters of the word form a word in the French language (1010). For example, the portable device 500 may remove the first character “d” from the word “dargent” and determine whether the word “argent” is a word in the French language. For example, the portable device 500 can determine whether the word “argent” is a French word using a French dictionary.

If the remaining characters of the word form a word in the French language, then the method 1000 inserts an apostrophe character between the first and the second characters of the word (1012). For example, if the portable device 500 determines that the word “argent” is a French word meaning “silver,” then the portable device 500 corrects the word “dargent” into “d'argent” by inserting an apostrophe character between “d” and “a.”

FIG. 11 is a flow diagram illustrating an example method 1100 for correcting a compound in a German input. For example, the method 1100 can be performed by a portable device (e.g., the portable device 600). The method 1100 begins with determining whether a word is a compound word in the German language (1102). For example, the portable device 600 can determine whether the word “buchsrite” is a word in the German language by checking a user-selected language.

If the word is in German, then the method 1100 parses the word into one or more combination of constituent words (1104). For example, the portable device 600 parses the word “buchsrite” into constituent words in the German dictionary. In some examples, the constituent words may be combined to form a word equivalent to or closely equivalent to the original word.

Next, the method 1100 determines whether the constituent words are nouns (1106). For example, after determining whether the constituent words are nouns, the portable device 600 may filter the combinations having at least one constituent word that is not a noun.

The method 1100 compares the combinations of constituent words (1110). For example, the portable device 600 can compare the combinations of constituent words based on a similarity between the combination of constituent words and the input word.

Next, the method 1100 corrects the compound word based on a combination of constituent words (1112). For example, the portable device 600 can correct the compound word “buchsrite” using the combination of constituent words “buch” and “seite.” For example, the portable device 600 provides a correction option of “Buchseite” for the word “buchsrite.”

In some implementations, the method 1100 in FIG. 11 may be adjusted to identify other contraction words in other languages. In some implementations, a portable device can detect contractions of words in position other than between the first and the second characters of word. In one implementation, the portable device can detect a contraction between the last and the second last characters of a word. For example, the portable device can correct a word “cant” to a word “can't” by detecting the contraction between the last and the second last character of “can't.”

Although several implementations are described, other implementation of the portable device 100 may also be possible. In some implementations, the portable device 100 is configured to dynamically determine the user-selected language. For example, the portable device 100 can adjust the user-selected language based on current user input. In one example, the portable device 100 can change the user-selected language from English to German after detecting a predetermined number of words are input in German. In some implementations, the keyboard layout can also be determined automatically based on user inputs. In one example, if a number of consecutive input words correspond to words in the English language and not other languages, the English keyboard layout can be selected. Thereafter, if several user input words correspond to words in the German language and not other languages, the German keyboard layout can be selected. Accordingly, the portable device 100 can provide a dynamically adjusted input correction service without requiring the user to change the user-selected language.

FIG. 12 is a block diagram of an example system architecture 1200 for performing the various operations described in reference to FIGS. 1-11. For example, the architecture 1200 may be included in the portable device 100, 400, 500, or 600, described in reference to FIGS. 1 and 4-6. The architecture 1200 includes a processor 1210, a memory 1220, a storage device 1230, and an input/output device 1240. Each of the components 1210, 1220, 1230, and 1240 are interconnected using a system bus 1250. The processor 1210 is capable of processing instructions for execution within the architecture 1200. In some implementations, the processor 1210 is a single-threaded processor. In other implementations, the processor 1210 is a multi-threaded processor. The processor 1210 is capable of processing instructions stored in the memory 1220 or on the storage device 1230 to display graphical information for a user interface on the input/output device 1240.

The memory 1220 stores information within the architecture 1200. In some implementations, the memory 1220 is a computer-readable medium. In other implementations, the memory 1220 is a volatile memory unit. In yet other implementations, the memory 1220 is a non-volatile memory unit.

The storage device 1230 is capable of providing mass storage for the architecture 1200. In some implementations, the storage device 1230 is a computer-readable medium. In various different implementations, the storage device 1230 may be a floppy disk device, a hard disk device, an optical disk device, or a tape device.

The input/output device 1240 provides input/output operations for the architecture 1200. In some implementations, the input/output device 1240 includes a keyboard and/or pointing device. In other implementations, the input/output device 1240 includes a display unit for displaying graphical user interfaces.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, a wireless network, and the computers and networks forming the Internet.

The computer system can include clients and servers. A client and server are generally remote from each other and typically interact through a network, such as those described above with respect to FIG. 1. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. Logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
detecting a location of a touch actuation on a touch sensitive display;
determining a key selection associated with the touch actuation;
determining if one or more alternate key selections related to the key selection are to be displayed; and
if one or more alternate key selections related to the key selection are determined to be displayed, then displaying the one or more alternate key selections proximate to the location of the touch actuation.

2. The method of claim 1, wherein displaying the one or more alternate key selections proximate to the location of the touch actuation comprises displaying one or more the alternate key selections centrally disposed relative to the touch actuation.

3. The method of claim 1, wherein displaying the one or more alternate key selections proximate to the location of the touch actuation comprises displaying the one or more alternate key selections relative to a location of a most recently actuated key.

4. The method of claim 1, wherein the key selection defines a character, and the one or more alternate key selections comprise accent options associated with the character.

5. The method of claim 4, further comprising displaying the one or more characters in an order based on frequency of occurrence of the accent options in a language.

6. The method of claim 4, further comprising displaying the one or more characters in an order based on the location of the touch actuation so that a most frequently occurring accent option is displayed closest to the touch actuation.

7. A method comprising:
obtaining text input;
determining text input error;
determining if the text input error corresponds to a liaison variant, a compound word or an accent option;
determining one or more correction options for the text input error;
determining a display location associated with the text input error, the display location on a display displaying the text input; and
displaying the one or more correction options on the display and proximate to the display location.

8. The method of claim 7, wherein determining a display location associated with the text input error comprises determining a location of a key associated with the text input error.

9. The method of claim 8, wherein displaying the one or more correction options on the display and proximate to the display location comprises displaying the one or more correction options relative to a location of a most recently actuated key.

10. The method of claim 9, wherein displaying the one or more correction options on the display and proximate to the display location comprises displaying the correction options relative to the location of the key and a display border.

11. A method comprising:
determining accent options for a selected character;
determining a display order for the accent options; and
displaying the accent options according to the display order.

12. The method of claim 11, further comprising:
receiving a user selection for one of the accent options; and
replacing the selected character with the selected accent option.

13. The method of claim 11, wherein determining a display order for the accent options comprises determining the display order based on frequencies of occurrence of the accent options in a language

14. The method of claim 11, further comprising:
determining a location of a touch actuation on the display; and
displaying the accent options in an order based on the location of a touch actuation so that a most frequency occurring accent option is displayed closest to the location of the touch actuation.

15. A method comprising:
obtaining a first input specifying a first virtual keyboard configured for a first language;
obtaining a second input specifying a second virtual keyboard configured for a second language; and
transitioning between displaying the first and second virtual keyboards.

16. A system comprising:
a touch sensitive display operable for detecting a location of a touch; and
a processor coupled to the touch sensitive display and operable for determining a key selection associated with the touch, for determining if one or more alternate key selections related to the key selection are to be displayed, and if one or more alternate key selections related to the key selection are determined to be displayed, for causing to display on the touch sensitive display the one or more alternate key selections proximate to the location of the touch.

17. The system of claim 16, wherein displaying the one or more alternate key selections proximate to the location of the touch actuation comprises displaying one or more of the alternate key selections centrally disposed relative to the touch.

18. The system of claim 16, wherein displaying the one or more alternate key selections proximate to the location of the touch actuation comprises displaying the one or more alternate key selections relative to a location of a most recently actuated key.

19. The system of claim 16, wherein the key selection defines a character, and the one or more alternate key selections comprise accent options associated with the character.

20. The system of claim 4, further comprising displaying the one or more characters in an order based on frequency of occurrence of the accent options in a language.

21. The system of claim 4, further comprising displaying the one or more characters in an order based on the location of the touch actuation so that a most frequently occurring accent option is displayed closest to the touch actuation.

22. A system comprising:
obtaining text input;
determining text input error;
determining if the text input error corresponds to a liaison variant, a compound word or an accent option;
determining one or more correction options for the text input error;
determining a display location associated with the text input error, the display location on a display displaying the text input; and
displaying the one or more correction options on the display and proximate to the display location.

23. The system of claim 7, wherein determining a display location associated with the text input error comprises determining a location of a key associated with the text input error.

24. The system of claim 8, wherein displaying the one or more correction options on the display and proximate to the display location comprises displaying the one or more correction options relative to a location of a most recently actuated key.

25. The system of claim 9, wherein displaying the one or more correction options on the display and proximate to the display location comprises displaying the correction options relative to the location of the key and a display border.

26. A system comprising:
determining accent options for a selected character;
determining a display order for the accent options; and
displaying the accent options according to the display order.

27. The system of claim 11, further comprising:
receiving a user selection for one of the accent options; and
replacing the selected character with the selected accent option.

28. The system of claim 11, wherein determining a display order for the accent options comprises determining the display order based on frequencies of occurrence of the accent options in a language

29. The system of claim 11, further comprising:
determining a location of a touch actuation on the display; and
displaying the accent options in an order based on the location of a touch actuation so that a most frequency occurring accent option is displayed closest to the location of the touch actuation.

30. A method comprising:
obtaining a first input specifying a first virtual keyboard configured for a first language;
obtaining a second input specifying a second virtual keyboard configured for a second language; and
transitioning between displaying the first and second virtual keyboards.
